(19) United States
(12) Patent Application Publication
(10) Pub. No.: US 2002/0091879 A1
(43) Pub. Date: Jul. 11, 2002

(54) System, method and apparatus for dynamic traffic management on a network

(76) Inventor: James Beriker, Westlake Village, CA (US)

Correspondence Address: Anna M. Vradenburgh, Brull, Piccionelli, Sarno, Brann & Vradenburgh, Eighteenth Floor, 1901 Avenue of the Stars, Los Angeles, CA, 90067, US

(21) Appl. No.: 10/029,483

(22) Filed: Dec. 20, 2001

Related U.S. Application Data
(60) Provisional application No. 60/257,695, filed on Dec. 21, 2000.

(51) Int. Cl. G06F 3/00

(52) U.S. Cl. 710/1

(57) ABSTRACT

A system, method and apparatus for dynamic traffic management on a network from a referral provider to target locations. A referral provider, such as a web master, operates a web site, wherein the referral provider has included a search box on the web site. A visitor to the site enters a search in the search box on the site of the referral provider, wherein the user search includes key terms or key words that are directed to the subject matter desired to be found. Once the user enters the key terms, a key term analyzer compares the user key terms with a predefined set of key terms. If the user key terms are included within the set of predefined key terms, the user is directed to a primary target location. If the user key terms are not included within the set of predefined key terms, the user is directed to an alternative target location.

### RELATED APPLICATION

This application is related to U.S. patent application, entitled A System, Method and Apparatus For Dynamic Traffic Management On A Network, Ser. No. 60/257,695 filed Dec. 21, 2000, and is fully incorporated herein by reference.

### FIELD OF THE INVENTION

The present invention is directed to a system, method and apparatus for traffic management on a network. More specifically, embodiments of the invention are directed to a traffic management system that allows for the dynamic routing of traffic from a referral provider to target locations.

### BACKGROUND OF THE INVENTION

An enormous amount of information is currently available on wide area networks, such as, the World Wide Web (“WWW”) or Internet. Unfortunately, the information is useless to users unless it can be found and accessed. To assist users in the retrieval of information on networks, search engines have been developed.

Overall, search engines allow a user to input key words or key terms that are related to the topic or subject matter for which the user desires to obtain information. The search engines search the network for information, for example, web sites, containing the key terms and return a listing of the locations of the information. Due to the enormous amount of information, a specific location containing information related to the key terms could be listed anywhere in the result list and thus, may never be reviewed by the user.

Information providers, such as web masters and web site owners, desire users to access their information, that is, their web site. In light of the manner in which search engines conduct searches, many web sites would be overlooked due to their position in the result listing. To aid in increasing the probability that a user would find and access a site, search engines have developed a prioritization scheme, wherein information providers pay the search engines for placement, or for position, in the result list.

In current prioritization structures, information providers purchase, or bid, on key terms. By purchasing key terms, the information provider will be given a priority position in the result list, thereby increasing the probability that the site of the information provider will be found and accessed by the user. Thus, when the user inputs a set of key terms for searching, information providers that have purchased the key terms in the user search, will be prioritized in the search result. In exchange for the prioritization in the search result list, the information provider pays the search engine the agreed upon purchase price if the information provider's site is accepted by the user requesting a search.

Currently, one modality of earning money from network based businesses, such as web sites, is through referral traffic, wherein traffic flow is directed from the current web site location to a target web site location. More specifically, traffic leaving a site is routed to locations chosen by a referral provider, that is, the web master or site owner from which the traffic emanates. Typically, the target location has agreed with the referral provider to pay for such traffic under certain conditions.

To capitalize on the referral payment system for traffic, with respect to pay for placement systems, currently, many referral providers include the ability for the visitor to the site, or user, to conduct a search. In most instances, the referral provider does not operate a search engine, but rather, directs this traffic, that is, the user implementing the search, to a search engine designated by the referral provider in advance. In current systems, the referral provider may be paid a preset amount for each user directed to the search engine, or payment may be based upon whether the user has included any key terms for which the search engine is paid.

At least one problem with the current system is that the referral provider is limited to the single search engine designated in advance for the directing of the traffic. Further, depending upon the payment agreement, the referral provider may not be paid for all of the traffic redirected to the search engine, or may only be paid a nominal amount for the traffic. A need in the industry exists for a system that allows a referral provider the ability to dynamically direct traffic to a target location; namely, a system that allows a referral provider to choose from multiple target locations depending upon the search requested by the user. A further need exists for a system that can increase the efficient use of business resources, in part, by increasing the probability of payment for the redirected traffic.

### SUMMARY OF THE DISCLOSURE

The present invention is directed to a system, method and apparatus for traffic management on a network; more specifically, a traffic management system that allows for the dynamic direction of traffic from a referral provider to target locations. Overall, in preferred embodiments, a referral provider, such as a web master, operates a web site, wherein the referral provider has included a search box on the web site. A visitor to the site, or user, can enter a search in the search box on the site of the referral provider, wherein the user search includes key terms or key words that are directed to the subject matter desired to be found. Once the user enters the key terms, a key term analyzer compares the user key terms with a predefined set of key terms. If the user key terms are included within the set of predefined key terms, the user is directed to a primary target location. If the user key terms are not included within the set of predefined key terms, the user is directed to an alternative target location.

A feature of embodiments of the invention is the dynamic direction of traffic on a network. An advantage to this feature is that referral providers can choose preferential business arrangements based upon each situation, for example, each search conducted. A further advantage to this feature is it increases the ability of the referral provider to utilize business resources more effectively.

A further feature of embodiments of the invention is the ability of the referral provider to predefine instructions for the directing of traffic that are dependent, in part, upon the input information for each situation. An advantage to this feature is that the referral provider can set up more advantageous arrangements and more effectively capitalize on the advantages of each new situation or opportunity to utilize business resources.

The above and other features and advantages of embodiments of this invention will be apparent from the following more detailed description when taken in conjunction with the accompanying drawings of illustrative embodiments.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 is a flow chart depicting a process for dynamically managing traffic on a network in a preferred embodiment of the invention.

### DETAILED DESCRIPTION OF PREFERRED EMBODIMENTS

Embodiments of the instant invention are directed to a system, method and apparatus for dynamically managing traffic on a network. Embodiments of the instant invention employ a network of computers and programs for retrieving and displaying content to users on a wide area network, such as, the WWW or the Internet.

Hardware Environment:

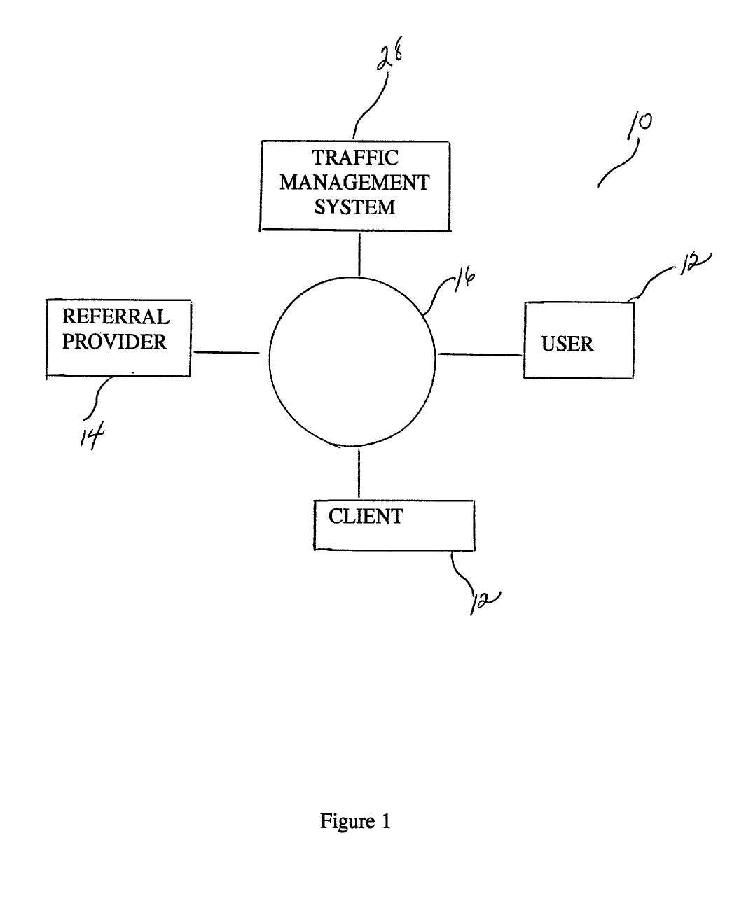

Preferred embodiments of the instant invention operate with a network comprising a plurality of networked computers, such as, for example, at least one user computer and at least one referral provider computer which are coupled together in a communications network, such as, for example, the Internet or WWW. FIG. 1 depicts a simplified representation of an example network system 10 that is operated in accordance with preferred embodiments of the invention.

The network system 10 includes at least two client or user computers 12, at least one referral provider computer 14 and a traffic management system 28 coupled for communication therebetween, generally represented at 16. In the illustrated embodiment, two client or user computers 12 and one referral provider computer 14 is shown in the network system. It will be understood that further embodiments may employ any suitable number of user and provider computers. The network system 10 may comprise a closed or intranet configuration, an open or public-access network configuration or combinations of such configurations, as is well known in the art. For example, the user and referral provider computers 12 and 14, and the dynamic management system 28 may be included in smaller, interconnected networks which compose the overall network system 10. In an Internet embodiment, the network system 10 comprises a combination of a large number of interconnected internets and intranets. For purposes of simplifying the present disclosure, the various hardware components (for example, host servers, routers, connectors) and software necessary for communication between computers on the network system are not described herein in detail. Such hardware and software are well within the scope of one of ordinary skill in the art and are at least partially dependent upon the type of network system employed and the desired application of use.

The user computer 12 may comprise any suitable network device capable of communicating with other network devices in the network system. In preferred embodiments, the user computer 12 comprises a programmable processor capable of operating in accordance with programs stored on one or more computer readable media 18 (for example, but not limited to floppy disc, hard disc, computer network, random access memory (RAM), CD Rom, or the like), a display device 20 for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device 22 (for example, but not limited to, a keyboard, mouse, microphone, or the like). In one preferred embodiment, the user computer comprises a personal computer system having a CRT display, a keyboard and a mouse user-input device.

The user computer 12 is controlled by suitable software, including network communication and browser software to allow a user to request, receive and display information (or content) from or through a referral provider computer 14 on the network system 10. In preferred embodiments, the user computer 12 employs a program, such as a browser, for displaying content received from a referral provider computer 14.

The provider computer 14 may comprise any suitable network device capable of providing content (data representing text, hypertext, photographs, graphics video and/or audio) for communication over the network. In preferred embodiments, the referral provider computer 14 comprises a programmable processor capable of operating in accordance with programs stored on one or more computer readable media 24 (for example, but not limited to, floppy disks, hard disks, random access memory RAM, CD-ROM), to provide content for communication to a user computer 12. The referral provider computer may comprise, for example, but is not limited to, a personal computer, a mainframe computer, network computer, portable computer, personal data assistant (such as, a 3Com Palm Pilot), or the like. The referral provider computer 14 may include one or more internal data storage devices (not shown) for storing content for communication to a user computer 12. Alternatively, or in addition, the referral provider computer 14 may be coupled to an external data storage device, computer or other means, generally represented at 26, from which the referral provider computer 14 may obtain content for communication to a user computer 12. In one embodiment, the external device 26 may comprise a further network device coupled in the network 16.

The traffic management system 28 may comprise any suitable network device capable of providing content (data representing text, hypertext, photographs, graphics video and/or audio) for communication over the network. In preferred embodiments, the traffic management system 28 may comprise, for example, but is not limited to, a personal computer, a mainframe computer, network computer, portable computer, personal data assistant (such as, a 3Com Palm Pilot), or the like. The traffic management system 28 is similar to the user computer 12 and referral provider 14, and thus, the descriptions set forth above for these devices 12,14 is fully applicable with regard to the traffic management system 28.

General Description of Preferred Embodiments:

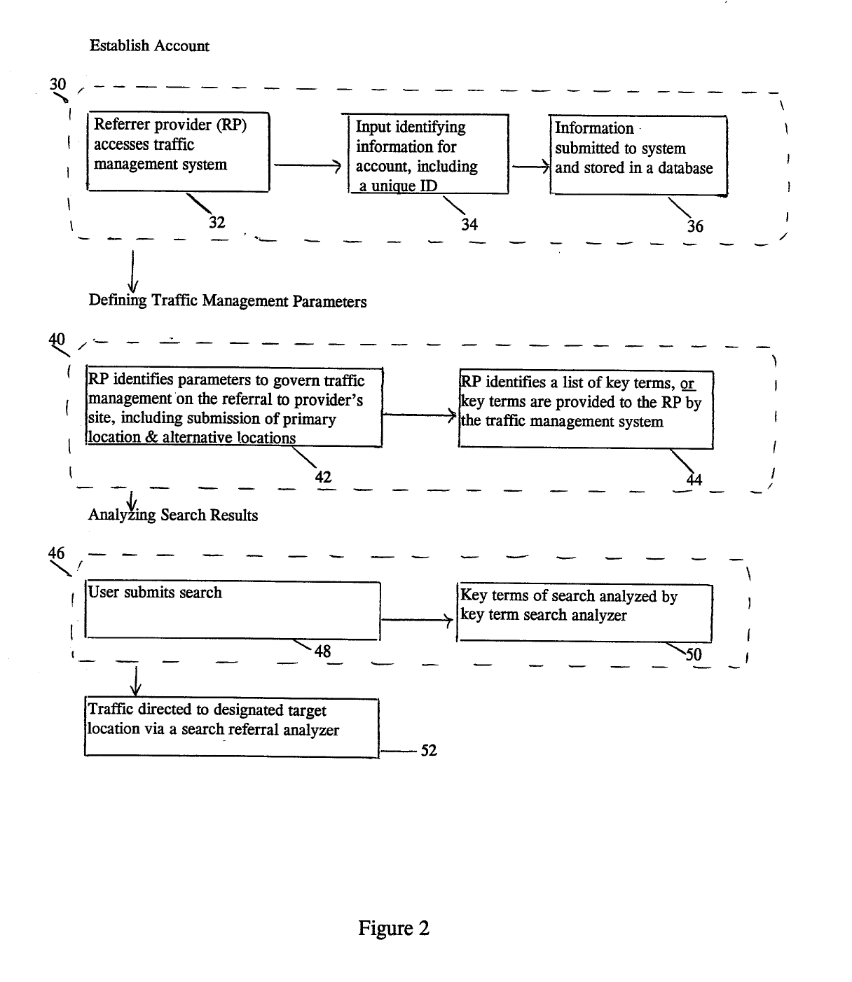

In preferred embodiments of the invention, a process for dynamically managing traffic on a network comprises establishing a participating account 30, defining traffic management parameters 40, analyzing a search request 46 and directing traffic to a target location 52. With reference to FIG. 2, to establish an account with the dynamic traffic management system 28, the referral provider accesses the traffic management system via an interface 30, such as a web page. The interface includes a ‘Set up Account’ button, or any other interface that may be suitable. Upon depression of the ‘Set up Account’ button, a set up page is transmitted to the referral provider 14, wherein the referral provider inputs identifying information, including, but not limited to, an account name, a unique identification and a password 32. The information is input via input boxes or via response to questions presented by the traffic management system 28. Once the referral provider is satisfied that the input information is accurate, the referral provider 14 submits the information to the system via a ‘Submit’ button. The input information is then validated by the traffic management system. Once the submitted information is validated, the submitted information is transmitted to an account storage database 36.

With reference again to FIG. 2, after the referral provider has established or opened an account, the referral provider defines traffic management parameters 40. To define the parameters, in one embodiment, the referral provider logs into the newly created account and accesses a ‘Traffic Management Parameters’ page, wherein the referral provider identifies parameters that will govern the management of the traffic on the referral provider's site 42. The management parameters include, but are not limited to, a primary location and an alternative location. In some embodiments, the management parameters further comprise a set of key terms.

The primary location is the target location defined by the referral provider as the principal location to which the traffic will be directed. The referral provider identifies the target location by any identifying indicator, including, but not limited to, an identifying name or a web address.

In addition to identifying the primary target location, the referral provider identifies the alternative target location. The referral provider identifies the alternative location by any identifying indicator, including, but not limited to, an identifying name or a web address. In some preferred embodiments, the referral provider can identify multiple alternative locations. If multiple alternative locations are identified, in some preferred embodiments, the traffic management system allows the referral provider to specify the percentage of traffic to direct to each alternative location. If no percentage of traffic for each alternative location is indicated, the direction of the traffic can be governed in accordance with a default standard such as 50-50 or with instructions, for example, to alternate between the alternative locations. It is to be understood that any number of alternative locations can be identified by the referral provider and that any manner of dividing up the traffic can be utilized, including, a combination of instructions, such as, 50% for a first alternative location, 10% for a second alternative location and alternating between a third and fourth alternative location.

The set of key terms is a set of search terms that is associated with the primary location and causes the referral provider's traffic to be directed to the predefined primary location. The key terms are chosen by the referral provider 44. In some embodiments however, the key terms are provided to the traffic management system by the primary location, and the referral provider does not have the option of submitting key terms to the traffic management system, but rather, is restricted to the key terms provided by the primary location.

Generally, the key terms chosen or identified by the referral provider are associated with key terms that have been purchased or otherwise provide income to the primary location. In preferred embodiments, the key term list generally selected by, or provided to, the referral provider is identical to all of the key terms purchased by third parties (e.g., information providers) from the primary location. In this manner, the referral provider is substantially guaranteed that all of the traffic directed to the primary location will produce income for the referral provider because all of the key terms have been paid for by information providers (e.g., web masters) whose identification or web location will be given preferential positioning within the result list presented to the user. Indeed, in specific embodiments wherein the key terms are provided by the primary location, only those key terms that will generate income are included on the key term list given to the referral provider.

Similarly, the alternative locations are generally chosen in accordance with the preferences by the referral provider, wherein the preferences are determined in part, by a beneficial business arrangement, e.g., monetary considerations, agreed upon by the referral provider and the alternative location. In some embodiments, the referral providers are allowed to choose the alternative locations or send the search to a flat rate program provided by the primary target location. Further, in still other embodiments, the traffic management system presents acceptable alternative locations to the referral provider from which to choose.

In another preferred embodiment, the referral provider is not required to log into the account to set traffic management parameters. In this embodiment, the traffic management system receives information regarding the primary and alternative locations via hypertext markup language (“html”) inserted into the search box. For example, in one preferred embodiment, code directing the traffic to an alternative location reads as follows: if ($form{alt_engine} eq “search123”) . It is to be understood that any means of identifying the primary and alternative locations is suitable, and the examples contained herein are not intended to limit the invention.

A similar code can be inserted for the primary target location. In one preferred embodiment, the primary target location is predefined by the traffic management system, and thus, no choice is indicated by the referral provider.

After the referral provider has set up an account, and identified account management parameters, the referral provider can utilize the traffic management system on its web site. Thus, when a user decides to conduct a search from the site, the user enters the applicable search terms or key terms into the search box and submits the search 48.

The submitted search is then analyzed by a key term search analyzer 50. The key term search analyzer is a software module that compares the key terms identified by the referral provider, or associated with the primary target location, with the key terms of the user defined search. If the key terms in the user defined search are identical, or substantially identical, to the user defined key terms, the user requesting the search is transmitted to the primary target location. In some preferred embodiments, a minimum matching threshold percentage is preset by the traffic management system. In these instances, if the minimum matching threshold is met, the user is transmitted to the primary target location. In specific embodiments, the search is predicated off an exact keyword match, or from related key words in the list, wherein related words include words that are related via a variety of preferences, including, but not limited to, spelling, bid amounts and subject matter. In one specific embodiment, the search analyzer matches words in the key list that correspond to a minimum bid amount or higher, such as, for example, 11 cents, wherein the limit is defined by the primary target location.

If a minimum matching threshold is not met, or the matching standard is not met, the user is directed to the alternative location in accordance with the parameters set forth by the referral provider. Thus, if only one alternative location is identified, then all traffic not directed to the primary target location is directed to the alternative location.

Once the search analyzer has determined the pathway for the traffic, the traffic management system directs the traffic to the designated target location via a search referral module 52. The search referral module is a software module that directs the traffic to the appropriate designation and, in some embodiments, provides tracking information for the traffic management system and the referral provider. In some embodiments, the search referral module is incorporated into the search analyzer and the task of directing the traffic to the target location is performed by the search analyzer upon the completion of its analysis of the search.

Although the foregoing described the invention with embodiments having particular forms that have been illustrated and described, this is not intended to limit the invention. For instance, although preferred embodiments have been described with reference to a wide area network, it is to be understood that embodiments of the invention are also applicable on other networks, including, but not limited to, a local network, an intranet and an internet. Indeed, the foregoing is intended to cover all modifications and alternative constructions falling within the spirit and scope of the invention as expressed in the appended claims.

What we claim is:

1. A system for providing traffic management on a computer network, wherein a referral provider and a user computer are in communication via the computer network, the referral provider predefining referral provider preferences via the traffic management system for routing traffic generated by the user computer's search request transmitted to the referral provider, wherein the routing of the traffic is dependent upon the search request transmitted by the user computer, comprising:
means for establishing an account for the referral provider, wherein the account includes an account name, a unique identification and a password;
at least one traffic management parameter; and
a search referral module, wherein the search referral module analyzes the user computer's search request.

2. A system as claimed in claim 1, the management parameters comprise at least one of a designated target location, and a set of key search terms.

3. A system as claimed in claim 2, wherein the search referral module routes traffic to the designated target location.

4. A system as claimed in claim 2, wherein the search request comprises a set of user defined search terms, and wherein the referral module compares the user defined search terms and the predefined set of key search terms of the management parameters.

5. A process for dynamically managing traffic on a network having a referral provider computer and a user computer, the user computer communicating with the referral provider computer and transmitting a search request to the referral provider computer, comprising:
establishing a participating account, wherein the account is established by the referral provider;
defining traffic management parameters;
analyzing the search request input by the user computer; and routing traffic to a target location.
